(19) United States
(12) Patent Application Publication
(10) Pub. No.: US 2008/0100097 A1
(43) Pub. Date: May 1, 2008

(54) PANEL MEMBER

(75) Inventors: Sen Tao, Utsunomiya-shi (JP); Keishi Okunaka, Utsunomiya-shi (JP); Hirotatsu Koda, Utsunomiya-shi (JP); Shinji Ago, Utsunomiya-shi (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 11/874,526

(22) Filed: Oct. 18, 2007

(30) Foreign Application Priority Data
Oct. 27, 2006 (JP) 2006-292327
Nov. 21, 2006 (JP) 2006-314518

(51) Int. Cl. B62D 27/02

(52) U.S. Cl. 296/191

(57) ABSTRACT

A panel member includes an outer panel and an inner panel which are superimposed one on the other and have a seamed edge. In the seamed edge, the outer panel has a distal end surface enclosed by the outer panel and gripped between the outer panel and the inner panel. The inner panel includes a flange as a curved portion in an edge thereof. The outer panel and the inner panel are stacked in at least four layers in the edge.

### BACKGROUND OF THE INVENTION

1. Field of the Invention

The present invention relates to a panel member comprising a plurality of superimposed plate members having edges fastened together by seaming.

2. Description of the Related Art

Panel members of the hood, trunk lid, and doors of automobiles have edges hemmed such that outer and inner panels are superimposed one on the other and the inner panel has an edge gripped by a bent flange on an edge of the outer panel.

Japanese Laid-Open Patent Publication No. 2003-170741 discloses a panel member for use in automobile doors which comprises an inner panel having an upstanding edge and an outer panel having a flange on an edge thereof which is bent to grip the upstanding edge of the inner panel, thereby fastening together the edges of the inner and outer panels. However, since the inner panel is merely gripped by the outer panel, the fastening strength of the inner and outer panels tends to be insufficient and the outer panel has an exposed tip end face which is susceptible to rust.

Japanese Laid-Open Patent Publication No. 10-128468 discloses a hemming structure of inner and outer panels wherein a flange on an edge of the outer panel includes a folded portion, and the inner and outer panels are fastened together by bending the flange until the folded portion is held in face-to-face contact with the inner panel, so that the tip end face of the outer panel is prevented from being exposed for protection against rust.

According to the related art referred to above, as shown in FIG. 27 of the accompanying drawings, when a flange 200a of an outer panel 200 is bent over to grip an edge of an inner panel 202, the bent portion of the outer panel 200 is subjected to forces in the directions indicated by the arrows A0 away from a round region R0. Therefore, the bent portion becomes somewhat round and has a large radius R0 of curvature, producing an unduly round surface which tends to result in a poor appearance.

Some panel members, such as panel members for use in automobiles, are of a three-dimensional shape having many curvatures on edges. When an edge of a panel is bent to produce a curved edge portion of such a three-dimensional panel member, such as a corner shown in FIG. 28 of the accompanying drawings, compressive or tensile forces act as indicated by the arrows in FIG. 29A of the accompanying drawings, and at the same time reactive forces for canceling out such compressive or tensile forces are produced in the curved edge portion as shown in FIG. 29B of the accompanying drawings. As a result, the curved edge portion suffers distortion or accuracy failure which is liable to impair the appearance as indicated by the arrows Rp, Rd in FIGS. 29A and 29B. One solution is to shorten the flange 200a of the outer panel 200 to prevent the corner from being wrinkled. However, the solution is not effective enough as it still results in a poor appearance.

According to the related art, since the outer panel 200 is merely bent over to grip the edge of the inner panel 202, an attempt is made to increase the fastening strength by bonding the outer panel 200 and the inner panel 202 to each other with an adhesive. The adhesive, however, is liable to eventually cause a reduction in fastening strength due to aging.

The hood, trunk lid, and doors of automobiles are repeatedly opened and closed. Therefore, the panel members thereof are required to be of high rigidity particularly in portions near their hinged ends (hinged portions) which are subject to large loads. On the other hand, other portions of the panel members do not need to be as rigid as the hinged portion because loads applied thereto are smaller than those on the hinged portions. In view of demands for panel members that are lighter and less costly, the other portions of the panel members may be made up of plate members which are less rigid than the hinged portions, e.g., thin plate members.

### SUMMARY OF THE INVENTION

It is an object of the present invention to provide a panel member which has an edge of excellent appearance and is of a high fastening strength even if the edge has a three-dimensional shape with many curvatures, the panel member is made up of plate members of different rigidities, etc., and the plate members include portions of different rigidities, shapes, etc.

According to an aspect of the present invention, there is provided a panel member comprising at least a first plate member and a second plate member which are superimposed one on the other and have a seamed edge, the first plate member including an end enclosed by the first plate member and gripped between the first plate member and the second plate member in the seamed edge, the first plate member and the second plate member being stacked in at least four layers.

The panel member of the above structure is of excellent appearance and has a seamed edge of high fastening strength even if the panel member is of a three-dimensional shape with many curvatures and the plate members have different rigidities, for example. As the second plate member includes the curved portion in the edge thereof, when the edge is compressed by seaming, the curved portion has its material flowing toward a corner thereof, thereby providing a sharply shaped edge.

According to another aspect of the present invention, there is provided a panel member comprising at least a first plate member and a second plate member which are superimposed one on the other and have a seamed edge, the seamed edge including a seamed first shape in which the first plate member includes an end enclosed by the second plate member and the second plate member includes an end enclosed by the first plate member, and a seamed second shape in which the end of the second plate member is enclosed by the first plate member and the end of the first plate member is not enclosed by the second plate member.

The panel member of the above structure is of excellent appearance and has a seamed edge of high fastening strength even if the panel member is of a three-dimensional shape with many curvatures and includes regions of different rigidities and shapes.

Particularly, even if at least one of the first plate member and the second plate member includes regions of different rigidities, the edge may be of good appearance by applying the first and second shapes to respective portions on opposite sides of a boundary in which the regions of different rigidities are joined to each other, for example.

The regions of different rigidities include at least a first region having a first rigidity and a second region having a second rigidity higher than the first rigidity, and the first region is included in an edge of the first shape and the second region is included in an edge of the second shape. With this structure, the edge of the panel member is of better appearance as the height (thickness) of the seamed edge and an outer edge surface thereof are uniformized highly reliably.

If the first region and the second region include respective portions of different lengths which are included in the seamed edge, then the edge of the panel member is substantially uniform in shape and is of good appearance even through the plate member includes a boundary in which the regions of different rigidities are joined to each other.

The one of the first plate member and the second plate member includes a recess defined in a range extending from an end thereof at a boundary in which the regions of different rigidities are joined to each other. Since the recess functions as a clearance when the edge is seamed, the plate member near the boundary is prevented from being abruptly deformed in irregular directions, and from buckling for better appearance, when the edge is seamed even in the vicinity of the boundary in which the regions of different rigidities are joined to each other.

According to an embodiment of the present invention, even if the panel member with the seamed edge has a three-dimensional shape with many curvatures or comprises plate members of different rigidities, the seamed edge is of excellent appearance and has high fastening strength.

According to another embodiment of the present invention, even if the panel member is of a three-dimensional shape with many curvatures in its seamed edge or comprises plate members including regions of different rigidities and shapes, the seamed edge is of excellent appearance and has high fastening strength because the edge includes a seamed first shape in which the first plate member includes an end enclosed by the second plate member and the second plate member includes an end enclosed by the first plate member, and a seamed second shape in which the end of the second plate member is enclosed by the first plate member and the end of the first plate member is not enclosed by the second plate member.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view, partly cut away, of a rear automobile door incorporating a panel member according to an embodiment of the present invention;

FIG. 2 is a front elevational view of the rear automobile door as viewed from the direction indicated by the arrow II in FIG. 1;

FIG. 3 is a perspective view, partly omitted from illustration, of a forming apparatus for fastening edges of the panel member according to the embodiment;

FIG. 4 is a flowchart of a process of fastening an edge of the panel member according to the embodiment;

FIG. 5A is a vertical cross-sectional view of workpieces, that are superimposed one on the other before the edge of the panel member according to the embodiment is fastened;

FIG. 5B is a vertical cross-sectional view showing the manner in which an edge of the outer panel is being curled;

FIG. 5C is a vertical cross-sectional view showing the manner in which the edge of the outer panel shown in FIG. 5B is being further curled;

FIG. 5D is a vertical cross-sectional view showing the manner in which the curled edge of the outer panel is seamed;

FIG. 6 is a side elevational view, partly omitted from illustration, of the forming apparatus shown in FIG. 3 wherein the workpieces are placed on a bed and fixed in place by a holding pad;

FIG. 7 is an enlarged vertical cross-sectional view, partly omitted from illustration, of parts around the workpieces shown in FIG. 6;

FIG. 8 is a side elevational view, partly omitted from illustration, of the forming apparatus shown in FIG. 3 wherein the workpieces are curled;

FIG. 9 is an enlarged vertical cross-sectional view, partly omitted from illustration, of parts around the workpieces shown in FIG. 8;

FIG. 10 is an enlarged vertical cross-sectional view, partly omitted from illustration, showing the manner in which the workpieces are further curled from the state shown in FIG. 9;

FIG. 11 is a side elevational view, partly omitted from illustration, of the forming apparatus shown in FIG. 3 wherein the workpieces are seamed;

FIG. 12 is an enlarged vertical cross-sectional view, partly omitted from illustration, of parts around the workpieces shown in FIG. 11;

FIG. 13A is an enlarged vertical cross-sectional view showing the manner in which an edge of an outer panel of a comparative example for the panel member according to the embodiment is curled;

FIG. 13B is an enlarged vertical cross-sectional view showing the manner in which the edge of the outer panel shown in FIG. 13A is further curled;

FIG. 13C is an enlarged vertical cross-sectional view of the curled edge of the outer panel shown in FIG. 13B which is seamed;

FIG. 14 is a plan view, partly omitted from illustration, of a corner of the panel member according to the embodiment;

FIG. 15 is a perspective view, partly omitted from illustration, of an edge of the corner shown in FIG. 14;

FIG. 16 is a perspective view of an automobile as seen from the front, showing locations thereon where the panel member according to the embodiment is applicable;

FIG. 17 is a perspective view, partly cut away, of a rear automobile door as a panel member according to another embodiment of the present invention;

FIG. 18A is a front elevational view of the rear automobile door as viewed from the direction indicated by the arrow XVIII in FIG. 17;

FIG. 18B is an enlarged view of an encircled portion XVIIIB shown in FIG. 18A;

FIG. 19A is a vertical cross-sectional view taken along line XIXA-XIXA of FIG. 18B;

FIG. 19B is a vertical cross-sectional view taken along line XIXB-XIXB of FIG. 18B;

FIG. 19C is a vertical cross-sectional view taken along line XIXC-XIXC of FIG. 18B;

FIG. 20 is a plan view, partly omitted from illustration, of superimposed outer and inner panels near a boundary line W before an edge of the panel member is fastened;

FIG. 21A is a vertical cross-sectional view taken along line XXIA-XXIA of FIG. 20;

FIG. 21B is a vertical cross-sectional view taken along line XXIB-XXIB of FIG. 20;

FIG. 21C is a vertical cross-sectional view taken along line XXIC-XXIC of FIG. 20;

FIG. 22 is a perspective view, partly omitted from illustration, which is illustrative of a process of curling edges of the superimposed outer and inner panels;

FIG. 23A is a vertical cross-sectional view showing a process of curling an outer panel and an inner panel including a first panel shown in FIG. 21A;

FIG. 23B is a vertical cross-sectional view showing a process of curling an outer panel and an inner panel including a second panel shown in FIG. 21B;

FIG. 23C is a vertical cross-sectional view showing a process of curling an outer panel and an inner panel including a recess shown in FIG. 21C;

FIG. 24A is a vertical cross-sectional view showing a process of seaming the curled edges shown in FIG. 23A;

FIG. 24B is a vertical cross-sectional view showing a process of seaming the curled edges shown in FIG. 23B;

FIG. 24C is a vertical cross-sectional view showing a process of seaming the curled edges shown in FIG. 23C;

FIG. 25 is a vertical cross-sectional view taken along line XXV-XXV of FIGS. 19A through 19C;

FIG. 26A is a vertical cross-sectional view showing another process of seaming the curled edges shown in FIG. 23A;

FIG. 26B is a vertical cross-sectional view showing another process of seaming the curled edges shown in FIG. 23B;

FIG. 27 is a vertical cross-sectional view showing an edge of a panel member according to the related art;

FIG. 28 is a plan view, partly omitted from illustration, of the panel member including a corner according to the related art shown in FIG. 27;

FIG. 29A is a perspective view, partly omitted from illustration, showing the manner in which a convex distortion is produced in the corner shown in FIG. 28; and

FIG. 29B is a perspective view, partly omitted from illustration, showing the manner in which a concave distortion is produced in the corner shown in FIG. 28.

### DESCRIPTION OF THE PREFERRED EMBODIMENTS

Panel members according to preferred embodiments of the present invention will be described in detail below with reference to the accompanying drawings.

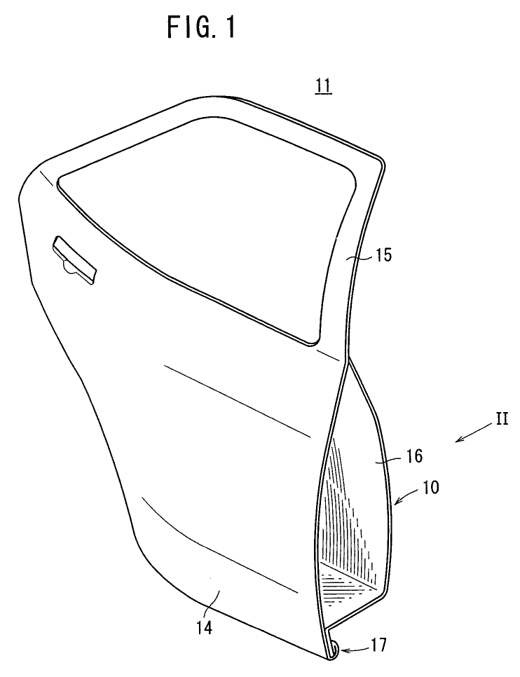

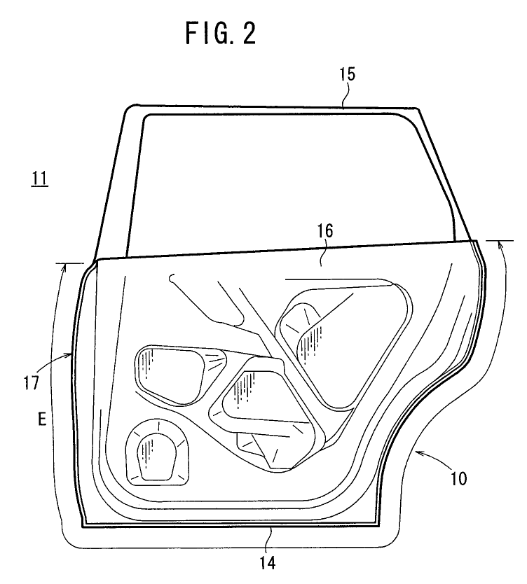

A panel member 10 (see FIGS. 1 and 2) according to an embodiment of the present invention will first be described below. As shown in FIGS. 1 and 2, a rear automobile door 11 comprises a panel member 10 made up of an outer panel 14 and an inner panel 16 which are superimposed one on the other and having an edge 17 fastened by seaming, and a window frame 15 disposed on an upper portion of the panel member 10. The fastened edge 17 includes a portion indicated by the arrow E in FIG. 2, and extends three-dimensionally substantially entirely along the panel member 10. If desired, the fastened edge 17 may extend along an outer edge of the window frame 15. Each of the outer panel 14 and the inner panel 16 is made of a sheet metal blank punched to a predetermined shape, for example.

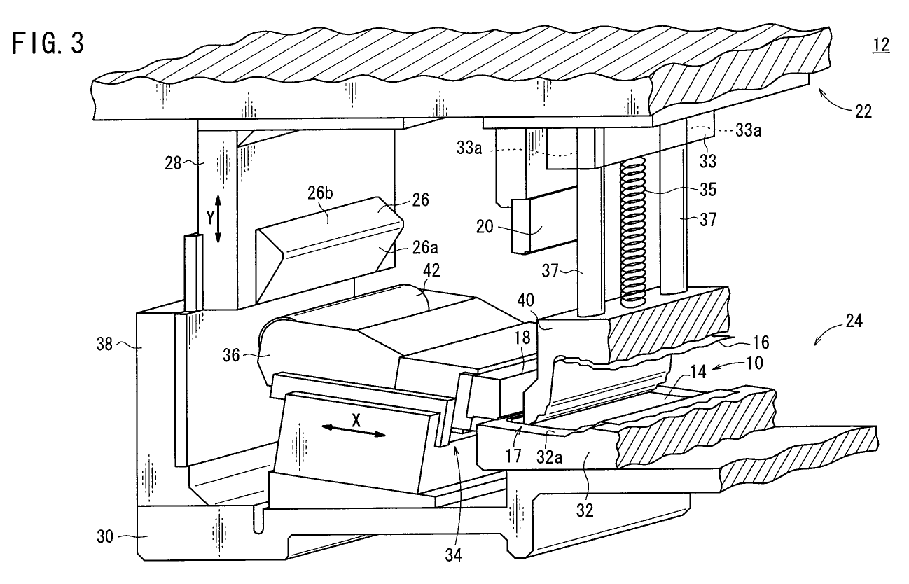

As shown in FIG. 3, a forming apparatus 12 forms the panel member 10 by superposing the outer panel (first plate member) 14 and the inner panel (second plate member) 16, which serve as workpieces, one on the other, curling the edge 17 of the outer panel 14 and the inner panel 16 with a curling punch (curling die) 18, and seaming the edge 17 with a seaming punch (compressing die) 20 thereby to fasten the edge 17.

The forming apparatus 12 comprises an upper die 22 which is vertically movable in the directions indicated by arrow Y in FIG. 3, and a lower die 24 disposed below the upper die 22 in confronting relation thereto.

The upper die 22 includes a driver cam 28 projecting downwardly from a lower surface thereof and including a pusher 26 in the form of a horizontally extending triangular prism, and the seaming punch 20 which is disposed above the edge 17 and projects downwardly.

The lower die 24 includes a base 30, a bed 32 mounted on the base 30 and having a bed surface 32a for placing thereon the outer panel 14 and the inner panel 16, a slide cam 36 movable in the forward and backward directions, i.e., in the directions indicated by the arrow X, by a slide mechanism 34, and a backup liner 38 projecting upwardly from an end of the base 30 for guiding the driver cam 28. The curling punch 18 is mounted on an end of the slide cam 36 which faces the bed 32. The bed 32 may be integral with the base 30.

A presser pad 40 for pressing and securing the outer panel 14 and the inner panel 16 placed on the bed surface 32a of the bed 32 is mounted on the lower surface of the upper die 22 by a support 33 disposed on the lower surface of the upper die 22 and a spring 35 disposed between the support 33 and the presser pad 40. A pair of parallel guide rods 37 positioned one on each side of the spring 35 is disposed between the support 33 and the presser pad 40. The guide rods 37 are axially movable in the forward and backward directions by bearings, not shown. The guide rods 37 have lower ends fixed to the presser pad 40 and upper ends inserted and supported in respective holes 33a defined in the support 33.

When the upper die 22 is lowered, the presser pad 40 pressed against the outer panel 14 and the inner panel 16 on the bed surface 32a while being guided by the guide rods 37. As the upper die 22 is further lowered, the spring 35 is compressed while the presser pad 40 remains secured in position on the outer panel 14 and the inner panel 16. At this time, the guide rods 37 guide the spring 35 as it is compressed while moving in the holes 33a in the support 33, the spring 35 is compressed without being unduly distorted, preventing the presser pad 40 from being displaced in position.

The slide mechanism 34 includes a resilient member such as a spring or the like, not shown, for normally biasing the slide cam 36 in one direction, i.e., toward the driver cam 28.

When the driver cam 28 descends in unison with the upper die 22, the slide cam 36 is moved forwards against the bias of the spring toward the bed 32 by a roller 42 that is pushed by a lower slanted surface 26a of the pusher 26. As the slide cam 36 moved forwards, the curling punch 18 slides on the bed surface 32a to curl the edge 17. Thereafter, the slide cam 36 is retracted backwards under the bias of the spring toward the driver cam 28 as the roller 42 rolls on an upper slanted surface 26b of the pusher 26. At the same time, the seaming punch 20 is lowered to seam the edge 17.

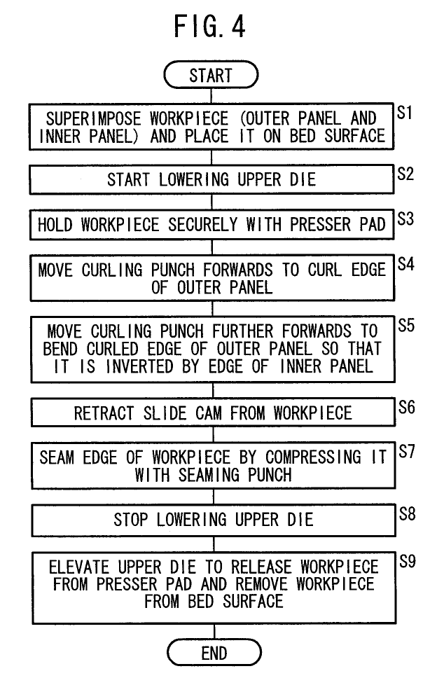

A fastening process of fastening the edge 17 of the outer panel 14 and the inner panel 16 as the workpiece by seaming to form the panel member 10 with the above-mentioned forming apparatus 12 will be described below with reference to FIG. 4. FIG. 4 is a flowchart of a process of fastening the edge of the panel member 10 according to the present embodiment.

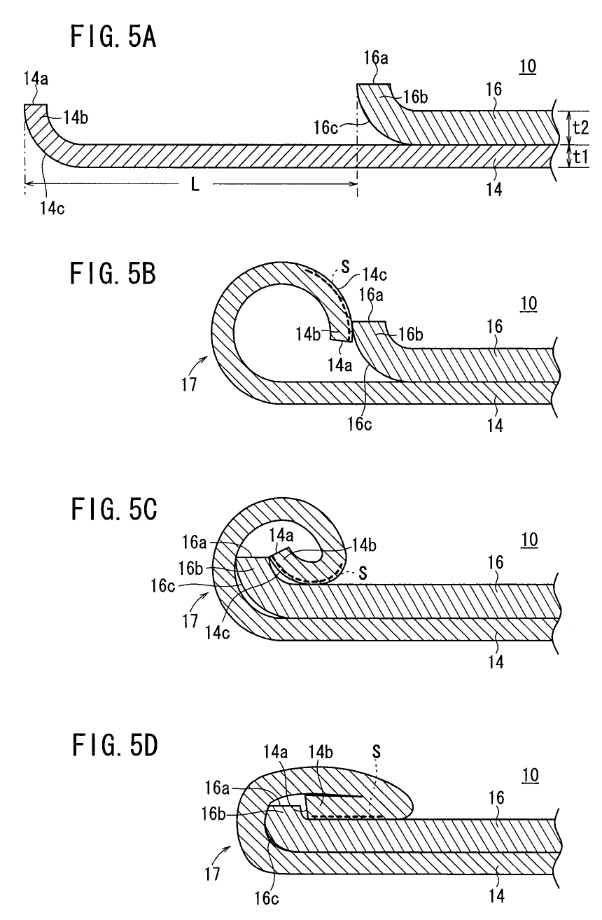

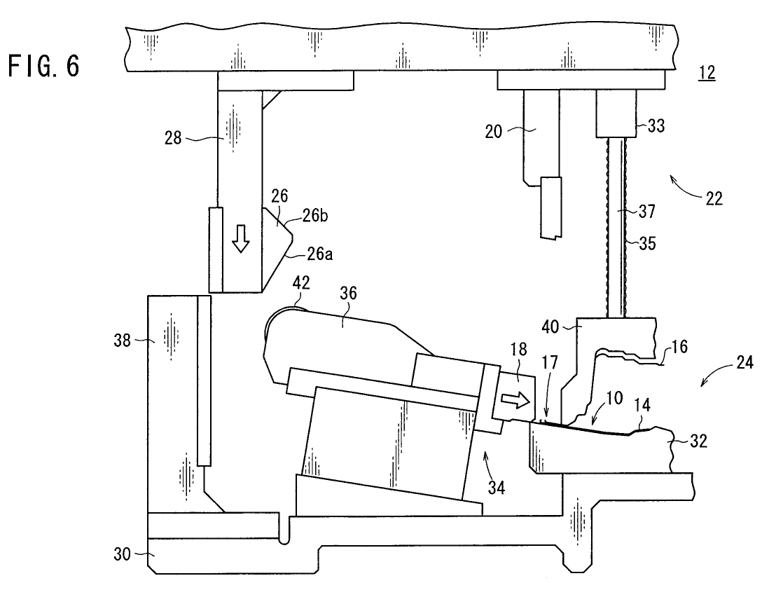

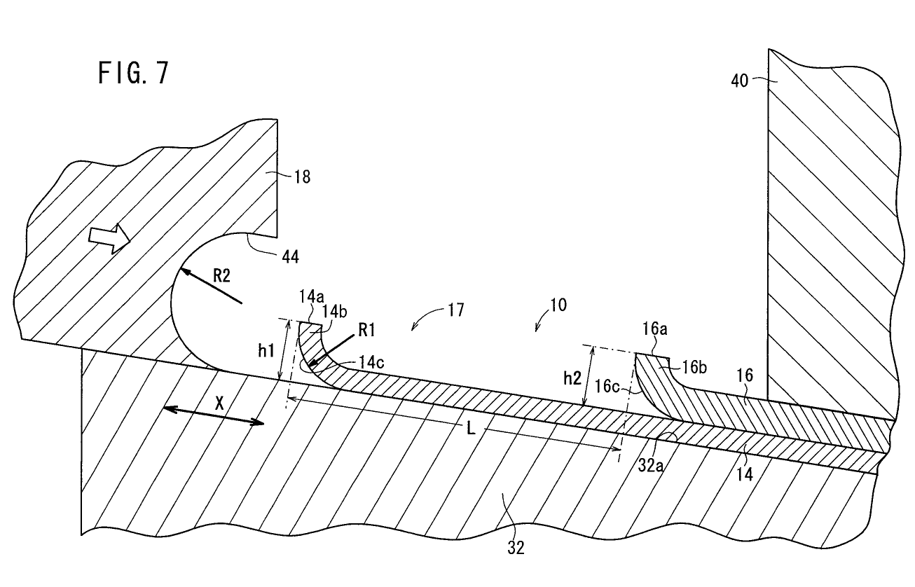

In step S1 shown in FIG. 4, the outer panel 14 and the inner panel 16 are superposed one on the other with a distal end surface (end) 14a of the outer panel 14 being displaced a distance L from a distal end surface (end) 16a of the inner panel 16, as shown in FIG. 5A, and are placed on the bed surface 32a of the bed 32 (see FIGS. 6 and 7).

The edges of the outer and inner panels 14, 16 which include the distal end surfaces 14a, 16a have been slightly curved in advance (pre-curved) into a flange (curved portion) 14b and a flange (curved portion) 16b, respectively.

With the panel member 10 according to the present embodiment, the thickness t2 of the inner panel 16 is sufficiently greater than the thickness t1 of the outer panel 14. Specifically, the thickness t1 of the outer panel 14 is set to 0.8 mm, for example, and the thickness t2 of the inner panel 16 to 1.2 mm, for example (t1<t2). The outer and inner panels 14, 16 are made of the same material or made of respective materials having the same mechanical strength. Accordingly, the rigidity of the inner panel 16 is sufficiently greater than the rigidity of the outer panel 14.

In step S2, the upper die 22 starts moving downwardly. As the upper die 22 descends, the driver cam 28 is progressively lowered along the backup liner 38. The presser pad 40 and the pusher 26 on the driver cam 28 are also lowered, and the seaming punch 20 is also progressively lowered toward the edge 17.

In step S3, the downward movement of the upper die 22 causes the presser pad 40 to press the outer and inner panels 14, 16 in the superimposed relation and secure them on the bed surface 32a (see FIGS. 6 and 7). As described above, the forming apparatus 12 has the presser pad 40 mounted on the upper die 22 by the support 33, the spring 35 and the guide rods 37. Therefore, while the outer and inner panels 14, 16 are being securely held on the bed surface 32a by the presser pad 40, the upper die 22 is continuously lowered to curl and seam the edge 17 continuously.

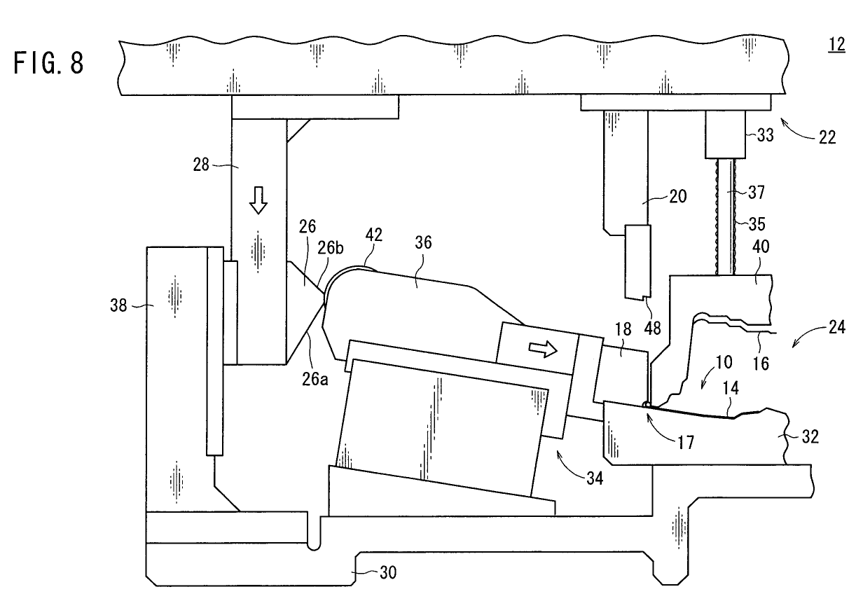

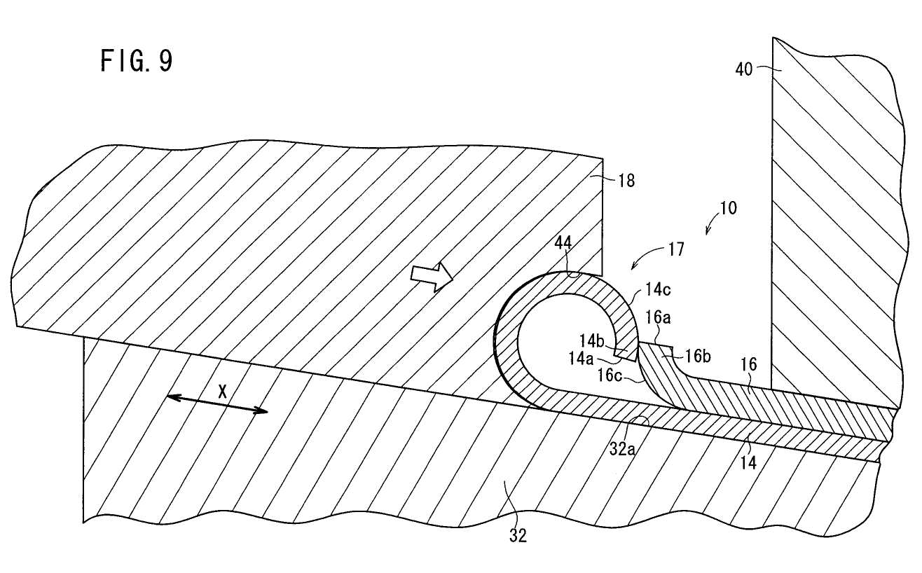

In step S4, the roller 42 of the slide cam 36 is engaged and pushed by the lower slanted surface 26a of the descending pusher 26 of the driver cam 28 lowering, moving the slide cam 36 forwards toward the bed 32 (see FIG. 8). The curling punch 18 slides forwards on the bed surface 32a to curl the edge 17 of the workpiece (see FIG. 9). Specifically, the edge of the outer panel 14 has an outer surface 14c contacted by a curling surface 44 provided by a substantially arcuate groove defined in the curling punch 18, and is curled into a shape complementary to the shape of the curling surface 44 (see FIGS. 5B and 9).

In the fastening process for fastening the panel member 10 according to the present embodiment, as shown in FIG. 7, the flange 14b of the outer panel 14 is curved (pre-curved) into a curved shape having a radius R1 of curvature, and the curling surface 44 of the curling punch 18 has a radius R2 of curvature. The radius R1 of curvature is set to 2.3 mm, for example, and the radius R2 of curvature is set to 2.5 mm (R1<R2). The curved shape into which the flange 14b is curved (pre-curved) corresponds to about one-quarter of a circle.

Consequently, the flange 14b has a height h1 which is substantially the same as the radius R1 of curvature. For example, the height h1 is in the range of 2.2 mm≦h1≦2.8 mm, for example. The distance L by which the outer panel 14 is displaced from the inner panel 16 is related to the radius R2 of curvature of the curling surface 44 for curling the edge of the outer panel 14, and is set to L=5.1R2 through 5.7R2, for example. The flange 16b of the inner panel 16 has a height h2 which is slightly smaller than the height h1 of the flange 14b of the outer panel 14, and is set to a value in the range from 1.8 mm≦h2≦2.4 mm.

In step S4, therefore, since the flange 14b is pre-curved into the curved shape which corresponds to about one-quarter of a circle, the curling surface 44 is held against the edge of the outer panel 14 which includes the distal end surface 14a and the flange 14b through a sufficiently wide area of contact during an initial phase of the curling process. Therefore, the edge of the outer panel 14 fits better with the curling surface 44, and the shape of the curling surface 44 is reflected highly accurately in the curled shape of the outer panel 14.

As the radius R1 of curvature of the flange 14b is slightly smaller than the radius R2 of curvature of the curling surface 44, as shown in FIGS. 5B and 9, the edge of the outer panel 14 is curled accurately along the shape of the curling surface 44. Then, the outer surface 14c of the edge of the outer panel 14 engages an outer surface 16c of the edge of the inner panel 16. The curled edge of the outer panel 14 is thus positioned outwardly of the edge of the inner panel 16.

In step S5, the curling punch 18 is moved further forwards on the bed surface 32a to press the edge of the outer panel 14 in engagement with the edge of the inner panel 16. In other words, the edge of the outer panel 14 is pressed against the edge of the inner panel 16 (see FIG. 5B).

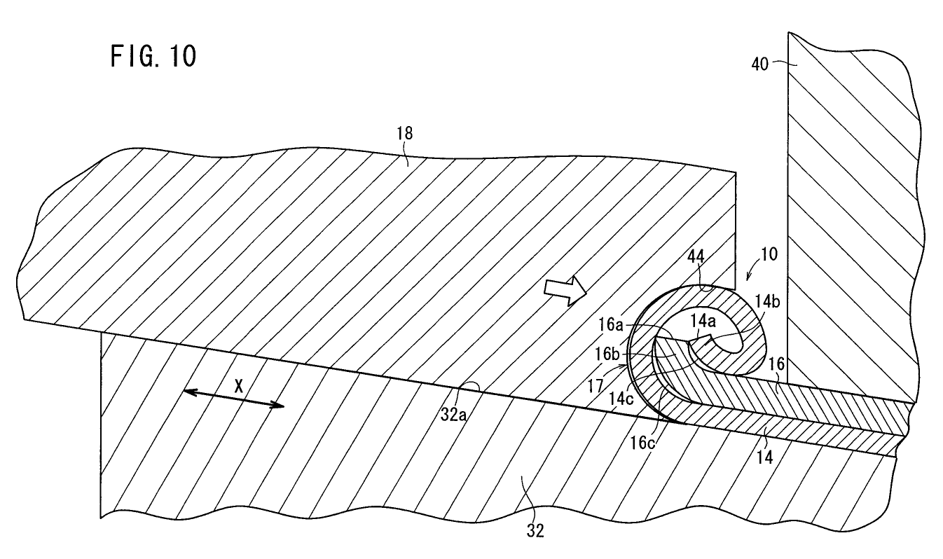

Since the inner panel 16 is sufficiently more rigid than the outer panel 14, the edge of the outer panel 14 is further curled while the outer surface 14c of the edge of the outer panel 14 is sliding on the outer surface 16c of the edge of the inner panel 16. Thereafter, frictional forces produced between the outer surfaces 14c, 16c cause the outer surface 14c of the outer panel 14 to ride onto the distal end surface 16a of the edge of the inner panel 16. The edge of the outer panel 14 is now inverted by the distal end surface 16a and is bent over the distal end surface 16a (see FIGS. 5C and 10).

As shown in FIG. 5C, the edge 17 of the panel member 10 is seamed with the distal end surface 14a of the outer panel 14 being enclosed by the outer panel 14 itself and gripped between the outer panel 14 and the inner panel 16. In the edge 17, the curved flange 16b is formed in the edge of the inner panel 16. Therefore, the outer panel 14 and the outer panel 16 are stacked in at least four layers in the edge 17.

As shown in FIG. 5C, the distal end surface 14a of the outer panel 14 and the distal end surface 16a of the inner panel 16 are bent substantially in the same direction.

In step S6, upon the continuous descent of the upper die 22, the slide cam 36 is retracted (moved backwards) away from the edge 17 of the workpiece along the upper slanted surface 26b of the pusher 26 of the driver cam 28 under the resiliency of the resilient member, not shown, of the slide mechanism 34 in the direction toward the driver cam 28.

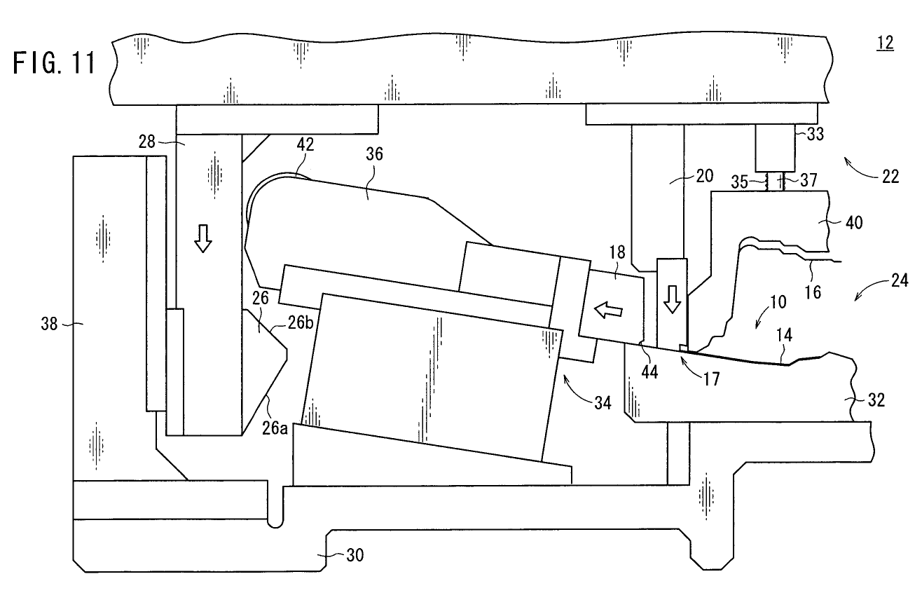

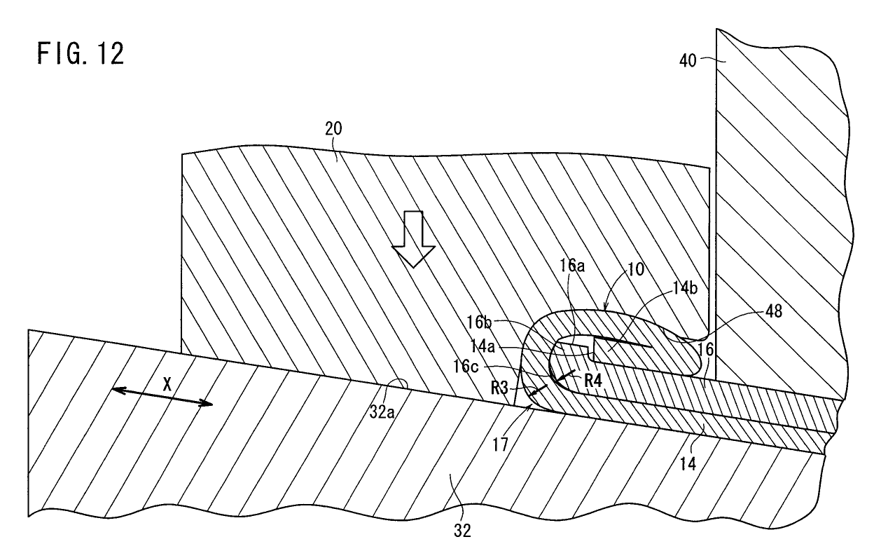

In step S7, at the same time the slide cam 36 is retracted away from the edge 17 of the workpiece, the seaming punch 20 is lowered in unison with the upper die 22 to deform flatly (compress) the curled edge 17 with a seaming surface 48 provided by a recess defined in the seaming pump 20 (see FIGS. 11 and 12). As shown in FIG. 5D, the curled edge 17 is seamed and firmly fastened into a neatly shaped appearance.

Thereafter, in step S8, the upper die 22 stops descending. In step S9, the upper die 22 is elevated to release the workpiece from the presser pad 40, and the panel member 10 with the edge 17 fastened by seaming is removed from the bed 32.

With the fastening process for fastening the panel member 10 according to the present embodiment, since the curling punch 18 is slid on the bed surface 32a to curl the edge 17, the outer and inner panels 14, 16 are fixedly placed on the bed surface 32a at all times. Therefore, the workpiece is prevented from buckling while the edge 17 is being curled.

Furthermore, the radius R1 of curvature of the flange 14b which is the curved edge of the outer panel 14 is slightly smaller than the radius R2 of curvature of the curling surface 44 of the curling punch 18. Therefore, the edge of the outer panel 14 is curled along the shape of the curling surface 44, and the curled edge of the outer panel 14 is guided outwardly of the edge of the inner panel 16.

As the flange 14b of the outer panel 14 is curved into a shape which corresponds to about one-quarter of a circle, the outer panel 14 is prevented from buckling when the edge 17 starts being curled by the curling punch 18, and the outer surface 14c of the edge of the outer panel 14 fits better with the curling surface 44. Therefore, the edge of the outer panel 14 is curled highly accurately.

The inner panel 16 is sufficiently more rigid than the outer panel 14. Consequently, when the curling punch 18 is moved forwards, the edge of the outer panel 14 is pressed against the edge of the inner panel 16, and is then inverted and bent by the distal end surface 16a of the inner panel 16, i.e., the curved flange 16b thereof (see FIGS. 5A through 5C).

When the edge of the outer panel 14 is pressed against and bent by the edge of the inner panel 16, the outer surface 14c of the edge of the outer panel 14 may possibly be damaged by the outer corner of the distal end surface 16a of the inner panel 16 (see the dotted line S in FIG. 5B). With the fastening process according to the present embodiment, however, the damaged surface indicated by the dotted line S is subsequently entrapped in the edge 17 as shown in FIGS. 5C and 5D. Accordingly, the damaged surface does not impair the appearance of the finished edge 17, and hence the edge 17 is of good appearance.

When the edge 17 is seamed after it has been curled, the outer and inner panels 14, 16 are prevented from buckling and hence the edge 17 is of excellent appearance. While the edge 17 is being seamed into a flatly deformed shape, the material of the outer panel 17 plastically flows in the vicinity of the edge 17. As shown in FIG. 12, the plastic flow sufficiently reduces the radius R3 of curvature of the outer panel 14 in the edge 17. The outer panel 14 is thus prevented from developing an unduly round surface on the edge 17, which is made better in appearance.

The edge of the inner panel 16 includes the curved flange 16b. When the edge 17 is pressed by the seaming surface 48 of the seaming punch 20, the material of the flange 16b flows in the direction indicated by the arrow R4 in FIG. 12, i.e., toward an outer corner of the flange 16b. As a result, the edge 17 is of a sharper shape free of an unduly round surface. The edge 17 may not necessarily be seamed as described above, and may be finished by curling only depending on the application of the panel member 10.

In the present embodiment, the radius R1 of curvature of the flange 14b on the curved edge of the outer panel 14 is slightly smaller than the radius R2 of curvature of the curling surface 44 of the curling punch 18 (R1 (2.3 mm)<R2 (2.5 mm)). However, the radii R1, R2 of curvature may be related to each other according to 0.8R2≦R1<R2, for example. With such a radius setting, the outer panel 14 can be curled accurately, and then inverted into a bent shape by the flange 16b.

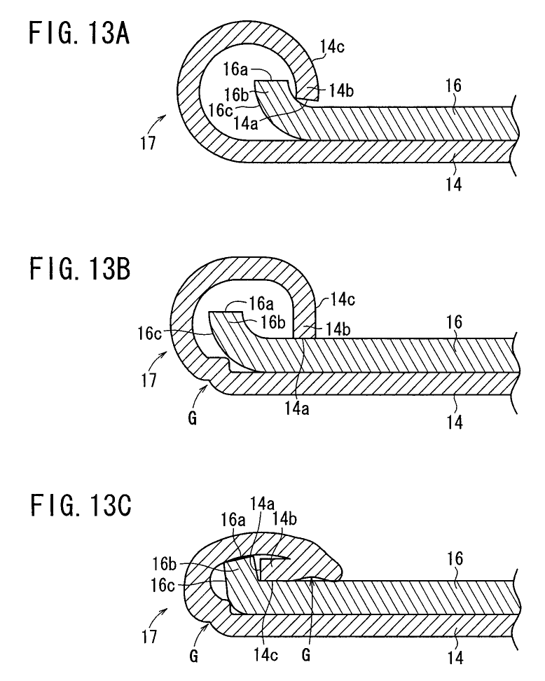

If the radii R1, R2 of curvature are related to each other according to R1>R2, for example, then, as shown in FIG. 13A, the edge of the outer panel 14 may be displaced over the flange 14b without engaging the edge of the inner panel 16. In this case, as shown in FIGS. 13B and 13C, when the edge 17 is curled and seamed, the outer panel 14 tends to suffer buckling G in different regions thereof, making it difficult to form a well shaped edge 17.

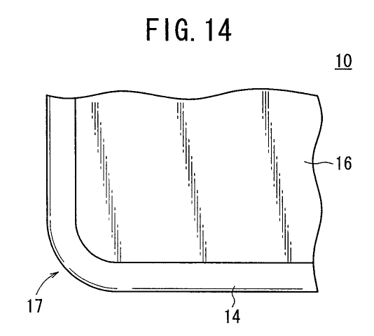

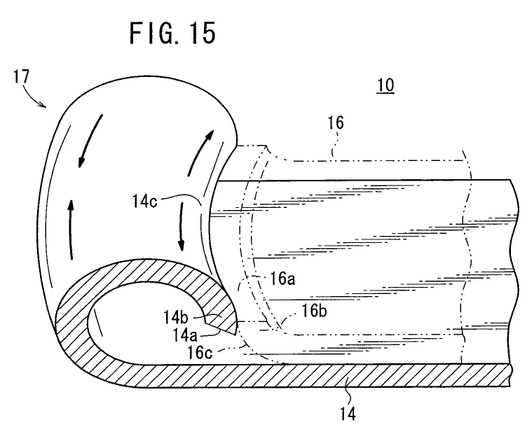

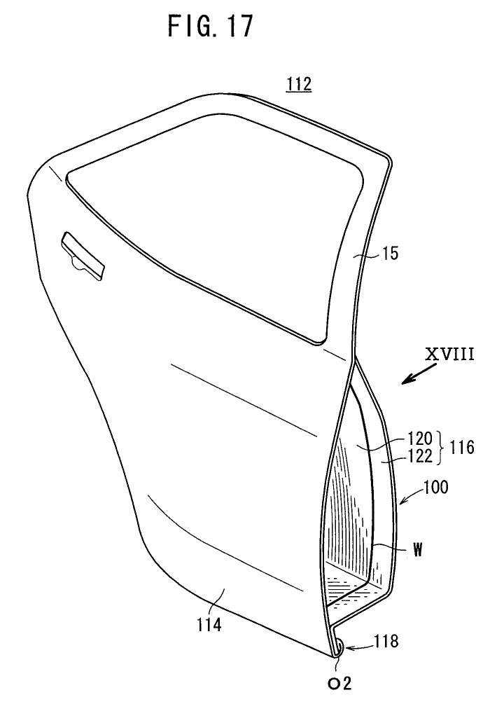

According to the present embodiment, since the edge 17 of the panel member 10 is seamed and fastened as described above, even if the panel member 10 has a corner, i.e., a curvature portion, as shown in FIG. 14, the corner undergoes forces applied in the directions indicated by the arrows in FIG. 15 when it is curled. Panel portions which have heretofore suffered distortions and accuracy failures that tend to impair the appearance according to the related art (see FIGS. 17 through 19B), e.g., corners of smaller curvature, are thus prevented from developing wrinkles without the need for reducing the length of the pre-curved flange.

In the edge 17 of the panel member 10, inasmuch as the distal end surface 14a of the outer panel 14 and the distal end surface 16a of the inner panel 16 are seamed without being exposed to the outside out, those distal end surfaces do not need to be treated for rust prevention, and hence the cost of the panel member 10 and the number of manufacturing steps therefor are reduced.

In the edge 17, the panels are stacked and fastened in at least four layers as described above. Therefore, the panel member 10 is of greater fastening strength and hence is stronger than the hemming structure of the related art.

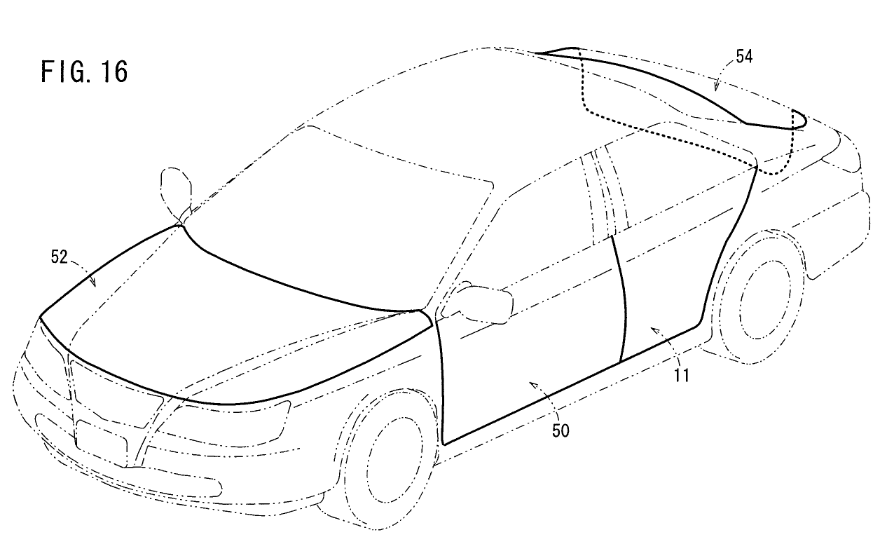

The rear automobile door 11 as an application of the panel member 10 according to the present embodiment has been described above. Of course, the panel member 10 according to the present embodiment is also applicable to other automobile components. For example, as shown in FIG. 16, the panel member 10 may be used as a front automobile door 50, a hood 52, a trunk lid 54, or the like. Furthermore, the panel member 10 may be used as panels other than automobile panels.

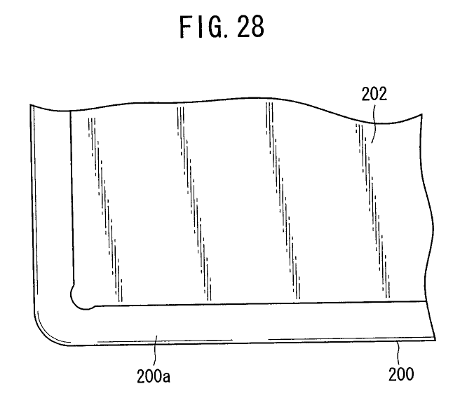

A panel member 100 according to another embodiment of the present invention will be described below with reference to FIGS. 17 through 28. Those parts of the panel member 100 shown in FIGS. 17 through 28 which are identical to those of the panel member 10 shown in FIGS. 1 through 16 are denoted by identical reference characters and will not be described in detail below as they have structures, functions, and advantages that are identical or similar to those described above.

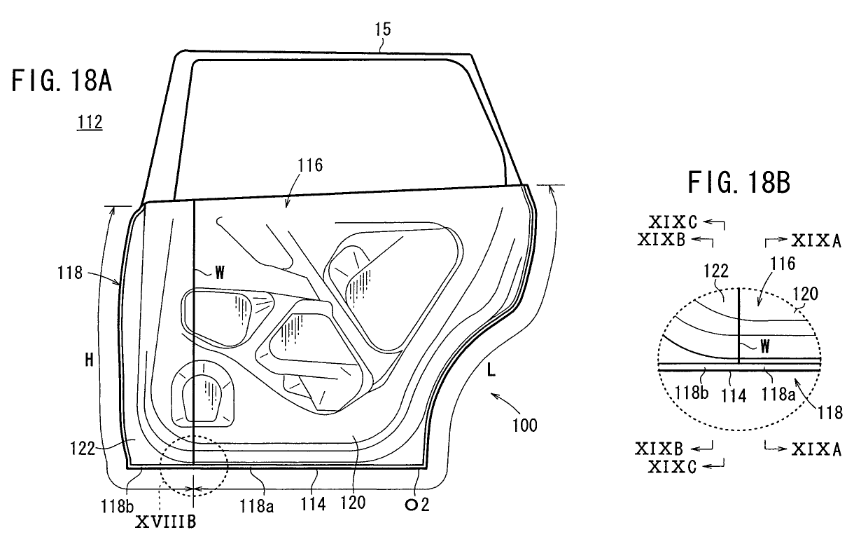

As shown in FIGS. 17, 18A, and 18B, a rear automobile door 112 comprises a panel member 100 made up of an outer panel (first plate member) 114 and an inner panel (second plate member) 116 which are superimposed one on the other and having an edge 118 fastened by seaming, and a window frame 15 disposed on an upper portion of the panel member 100. The fastened edge 118 includes a portion indicated by the arrow H and a portion indicated by the arrow L in FIG. 18A, and extends three-dimensionally substantially entirely along the panel member 100. If desired, the fastened edge 118 may extend along an outer edge of the window frame 15. The outer panel 114 is made of a sheet metal blank punched to a predetermined shape, for example.

The inner panel 116 comprises a first panel (first region) 120 including the portion indicated by the arrow L in FIG. 18A and a second panel (second region) 122 including the portion indicated by the arrow H in FIG. 18A. Each of the first and second panels 120, 122 is made of a sheet metal blank punched to a predetermined shape, for example. The first and second panels 120, 122 are joined by laser beam welding, for example, along a boundary line (boundary region) W in FIGS. 17 and 18A.

As shown in FIGS. 18A and 18B, the edge 118 includes a first edge 118a wherein the first panel 120 of the inner panel 116 and the outer panel 114 are fastened to each other, and a second edge 118b wherein the second panel 122 of the inner panel 116 and the outer panel 114 are fastened to each other. The first edge 118a and the second edge 118b are seamed in different shapes.

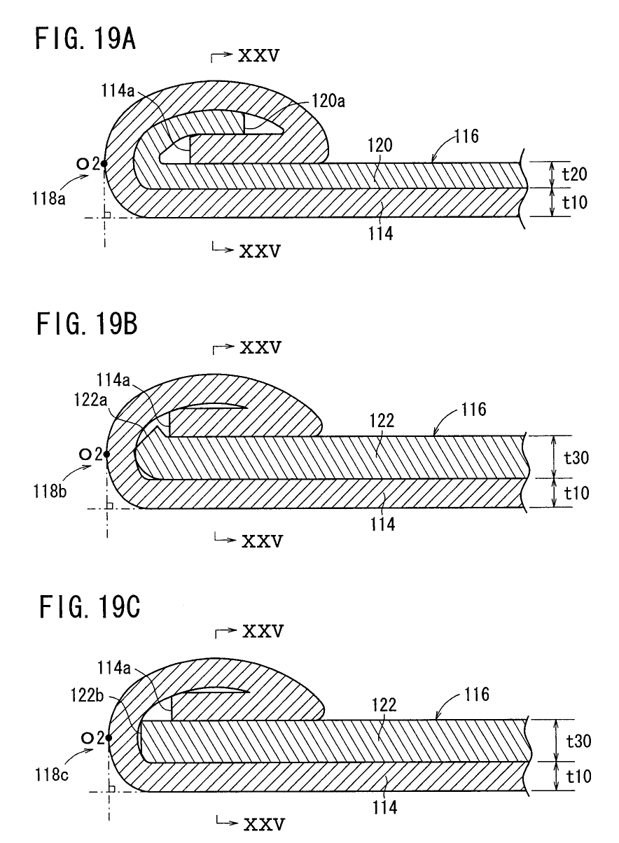

FIG. 19A is a vertical cross-sectional view taken along line XIXA-XIXA of FIG. 18B, showing a transverse cross-sectional shape of the first edge 118a of the edge 118. FIG. 19B is a vertical cross-sectional view taken along line XIXB-XIXB of FIG. 18B, showing a transverse cross-sectional shape of the second edge 118b of the edge 118. FIG. 19C is a vertical cross-sectional view taken along line XIXC-XIXC of FIG. 18B, showing a transverse cross-sectional shape of the second edge 118b of edge 118 near the boundary line W.

As shown in FIG. 19A, the first edge 118a of the edge 118 is seamed in a shape (first shape) such that the outer panel 114 has a distal end surface (end) 114a enclosed by the first panel 120, and the first panel 120 of the inner panel 116 has a distal end surface (end) 120a enclosed by the outer panel 114. As can be seen from FIG. 19A, the panels are stacked in a maximum of five layers along the height (thickness direction) in the first edge 118a. As shown in FIG. 19B, the second edge 118b of the edge 118 is seamed in a shape (second shape) such that the second panel 122 of the inner panel 116 has a distal end surface (end) 122a enclosed by the outer panel 114, and the distal end surface 114a of the outer panel 114 is not enclosed by the second panel 122. As can be seen from FIG. 19B, the panels are stacked in a maximum of four layers along the height (thickness direction) in the second edge 118b.

As shown in FIG. 19C, the edge 118 on the second panel 122 near the boundary line W has a third edge 118c which is of substantially the same shape as the second edge 118b (substantially the same shape as the second shape) except that the second panel 122 is free of any bends but is essentially flat, and where the outer and inner panels 114, 116 are seamed. The edge 118 on the first panel 120 near the boundary line W is seamed in substantially the same shape as the third edge 118c shown in FIG. 19C except that the first panel 120 is thinner than the second panel 122.

In the first edge 118a, the thickness t20 of the first panel 120 is slightly smaller than the thickness t10 of the outer panel 114. In the second edge 118b, the thickness t30 of the second panel 122 is sufficiently greater than the thickness t10 of the outer panel 114. In the edge 118, the thicknesses t20, t10, t30 of the panels are set respectively to 0.65 mm, 0.8 mm, and 1.2 mm, for example (t20<t10<t30). The panels of the panel member 100 according to the present embodiment are made of the same material or made of respective materials having the same mechanical strength. Specifically, the inner panel 116 is of a joined structure comprising the second panel 122 which has a large thickness and a high rigidity and the first panel which is smaller in thickness and rigidity than the second panel 122. Stated otherwise, the inner panel 116 is constructed of the first panel (first region) 120 having a first rigidity and the second panel (second region) 122 having a second rigidity which is higher than the first rigidity.

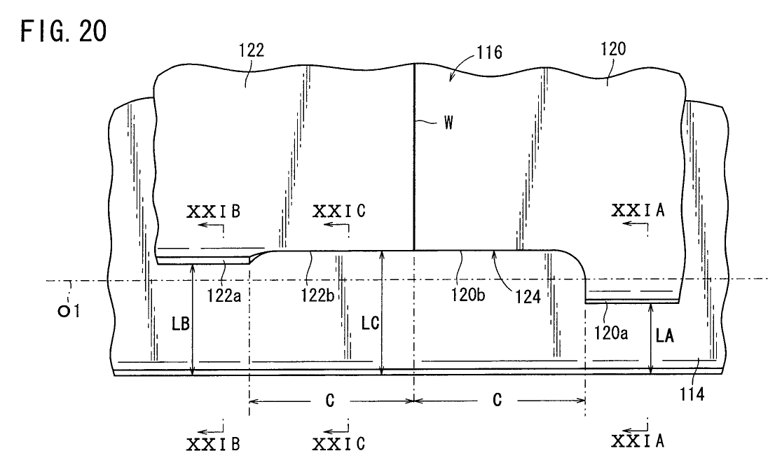

A process of forming the edge 118 of the panel member 100 according to the present embodiment will be described below primarily with reference to FIGS. 20 through 26B.

As shown in FIG. 20, the outer panel 114 and the inner panel 116 are superimposed one on the other with the outer panel 114 being displaced from the inner panel 116 by distances LA, LB, LC.

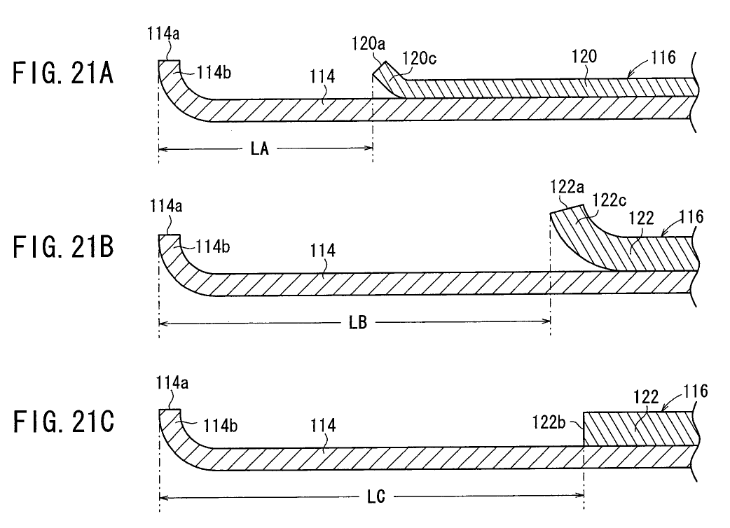

The first panel 120 has a distal end surface 120a spaced the distance LA from a distal end surface 114a of the outer panel 114 (see FIGS. 20 and 21A), and the second panel 122 has a distal end surface 122a spaced the distance LB from the distal end surface 114a of the outer panel 114 in the inner panel 116 (see FIGS. 20 and 21B). As can be seen from FIG. 20, the distance LB is greater than the distance LA, i.e., the first panel 120 and the second panel 122 of the inner panel 116 are joined to each other such that the distal end surface 120a of the first panel 120 projects more closely to the distal end surface 114a of the outer panel 114 than the distal end surface 122a of the second panel 122.

The inner panel 116 has a recess (escape) 124 defined therein over a predetermined distance from its distal end in predetermined ranges C, C which extend from the boundary line W to the distal end surface 114a. The distal end surfaces 120b, 122b of the first and second panels 120, 122 are positioned in the recess 124 and spaced the distance LC from the distal end surface 114a of the outer panel 114 (see FIGS. 20 and 21C). Therefore, the recess 124 in the inner panel 116 extends a distance which is represented by the difference between the distance LA or LB and the distance LC. FIG. 21C is a vertical cross-sectional view of the panel member across the recess 124 in the second panel 122. However, the panel member across the recess 124 in the first panel 120 is of a similar vertical cross section except for the different thickness of the first panel 120.

At the time the outer panel 114 and the inner panel 116 are superposed one on the other, the edges of the outer and inner panels 114, 116 which include the distal end surfaces 120a, 122a except the recess 124 have been slightly curved in advance (pre-curved) into a flange 114b and flanges 120c, 122c (see FIGS. 21A through 21C).

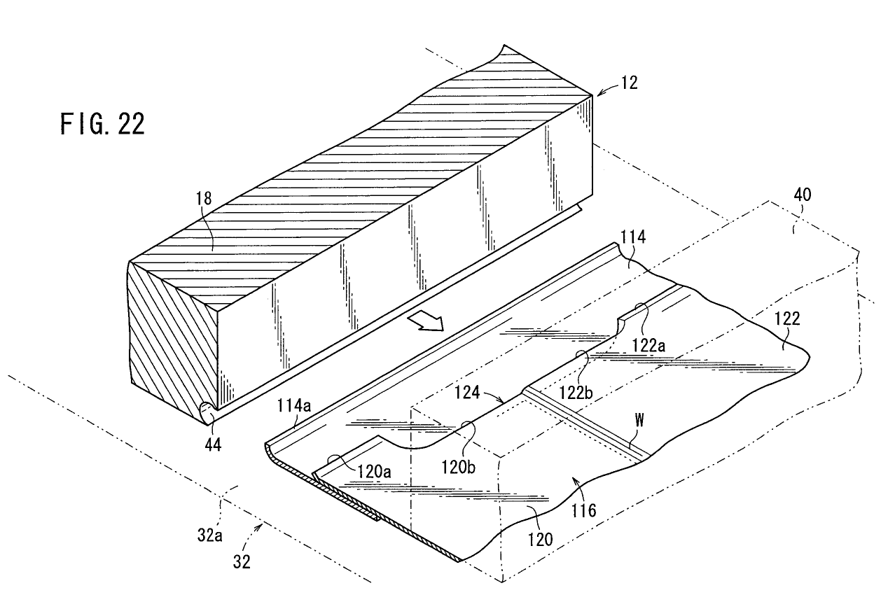

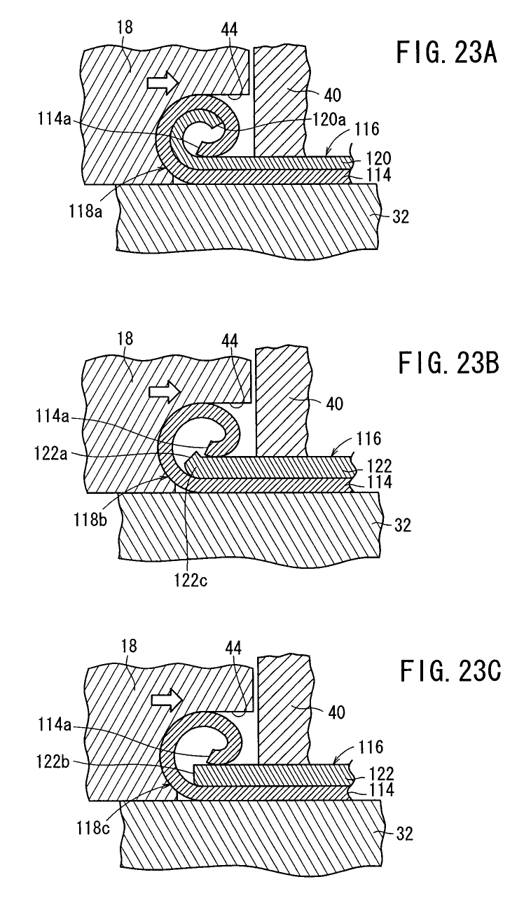

Then, the portion of the outer panel 114 which includes the distal end surface 114a that is spaced from the inner panel 116 by the distances LA, LB, LC is curled into an edge 118 of substantially circular cross section (see FIGS. 22 and 23A through 23C).

The outer panel 114 is curled as follows: As shown in FIG. 22, the superimposed outer and inner panels 114, 116 are placed on the bed surface 32a of the bed 32 of the forming apparatus (see FIG. 3), and are pressed down against the bed surface 32a by the presser pad 40. Then, the curling surface 44 of the curling punch 18 is slid on the bed surface 32a to curl the outer panel 114 from its distal end surface 114a.

As shown in FIG. 23A, the edge of the region where the outer panel 114 and the first panel 120 of the inner panel 116 are superimposed one on the other is curled into a first edge 118a wherein the distal end surface 114a of the outer panel 114 is enclosed by the first panel 120 and the distal end surface 120a of the first panel 120 is enclosed by the outer panel 114. As shown in FIG. 23B, the edge of the region where the outer panel 114 and the second panel 122 of the inner panel 116 are superimposed one on the other is curled into a second edge 118b wherein the distal end surface 122a of the second panel 122 is enclosed by the outer panel 114 and the distal end surface 114a of the outer panel 114 is not enclosed by the second panel 122. Similarly, as shown in FIG. 23C, the edge of the second panel 122 which includes the recess 124 is curled into a third edge 118c which is of substantially the same shape as the second edge 118b except that the second panel 122 is free of any bends but is essentially flat. The edge of the first panel 120 which includes the recess 124 is also curled into an edge which is of substantially the same shape as the third edge 118c shown in FIG. 23C except that the first panel 120 is thinner than the second panel 122.

With the panel member 100 according to the present embodiment, the curled edge 118 may be seamed. Specifically, the curled edge 118 is pressed so as to be deformed flatly, i.e., compressed for increased fastening strength and improved appearance.

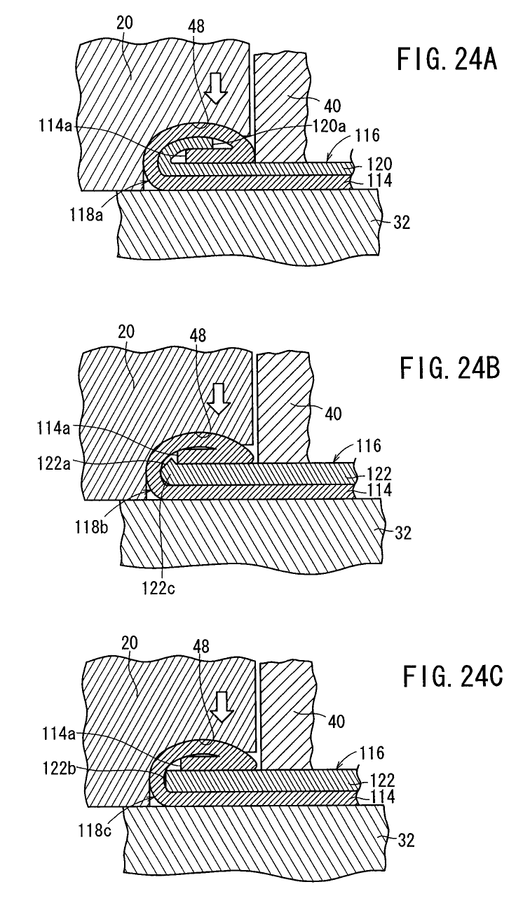

The curled edge 118 is seamed as follows: After the edge 118 is curled on the bed surface 32a, the curling punch 18 is retracted (moved backwards) while the outer and inner panels 114, 116 are being securely held in position by the presser pad 40, and the seaming surface 48 of the seaming punch 20 is lowered to deform flatly and hence seam the curled edge 118 (see FIGS. 24A through 24C). As shown in FIGS. 19A through 19C, therefore, the edge 118 is of good appearance and securely fastened with the panels being firmly held in close contact together.

When the edge 118 is thus seamed, an edge line O1 indicated by the dot-and-dash line in FIG. 20 and edge points O2 (see FIGS. 19A through 19C) on the edge 118 of the formed panel member 100 which includes the first edge 118a, the second edge 118b, and the third edge 118c are held in positional agreement with each other. The edge line O1 and the edge points O2 represent the position of an outer edge of the panel member 100. In the formed panel member 100, as the edge points O2 on the edge 118 which includes the first edge 118a, the second edge 118b, and the third edge 118c are arrayed on the edge line O1, the outer edge of the panel member 100 is smoothly formed (see FIGS. 17 and 18A).

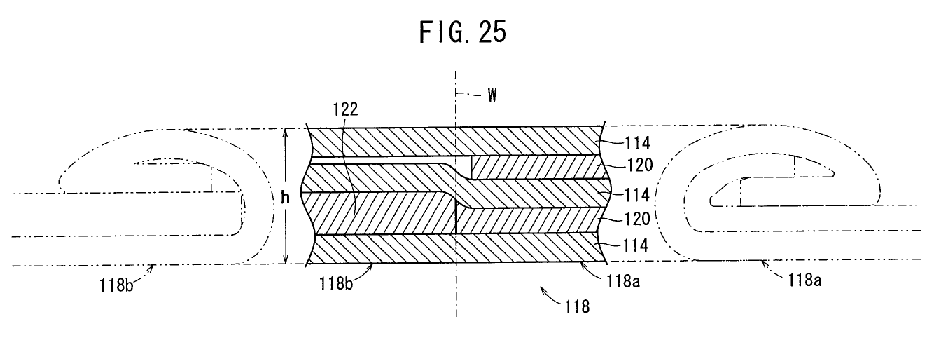

As shown in FIG. 25, the seamed edge 118 has an essentially constant height (thickness) h to provide a seamed configuration of good appearance in the vicinity of the boundary line W where the first and second panels 120, 122 of different thicknesses, i.e., different rigidities, are joined to each other, because the first and second panels 120, 122 have different lengths (the distances LA, LB) and the recess 124 is provided.

The edges of the first and second panels 120, 122 are spaced different distances from the distal end surface 114a of the outer panel 114. Even though the inner panel 116 includes the first and second panels 120, 122 of different rigidities, the edge points O2 are held in alignment with the edge line O1 and the height h is made essentially constant. Therefore, as shown in FIGS. 19A through 19C, the lengths of the first and second panels 120, 122 which are included in the seamed edge 118 are different from each other. Specifically, the length of the first panel 120 which is included in the seamed edge 118 is greater than the length of the second panel 122 which is included in the seamed edge 118. At the recess 124, the lengths of the first and second panels 120, 122 which are included in the seamed edge 118 are smaller than those outside of the recess 124.

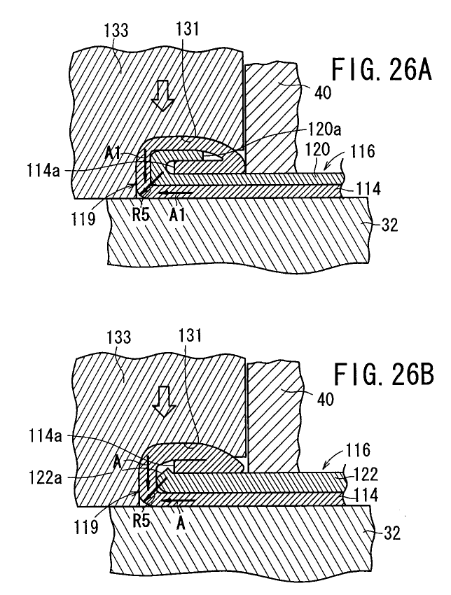

As shown in FIGS. 26A and 26B, the edge 118 may be punched into a seamed edge 119 by a seaming punch 133 having a seaming surface 131 which is smaller than the seaming punch 20 shown in FIGS. 24A through 24C. When the seaming punch 133 is used, the material of the outer and inner panels 114, 116 plastically flows while the edge 118 is being deformed flatly into the seamed edge 119. The plastic flow produces forces in the directions indicated by the arrows A1 in FIGS. 26A and 26B to sufficiently reduce the radius R5 of curvature of the edge 119. The outer panel 114 is thus prevented from developing an unduly round surface on the edge 119, which is made better in appearance.

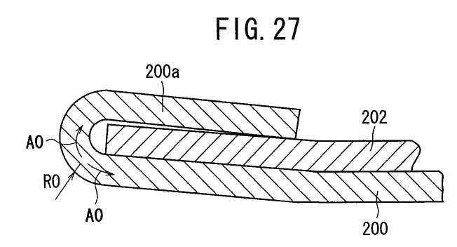

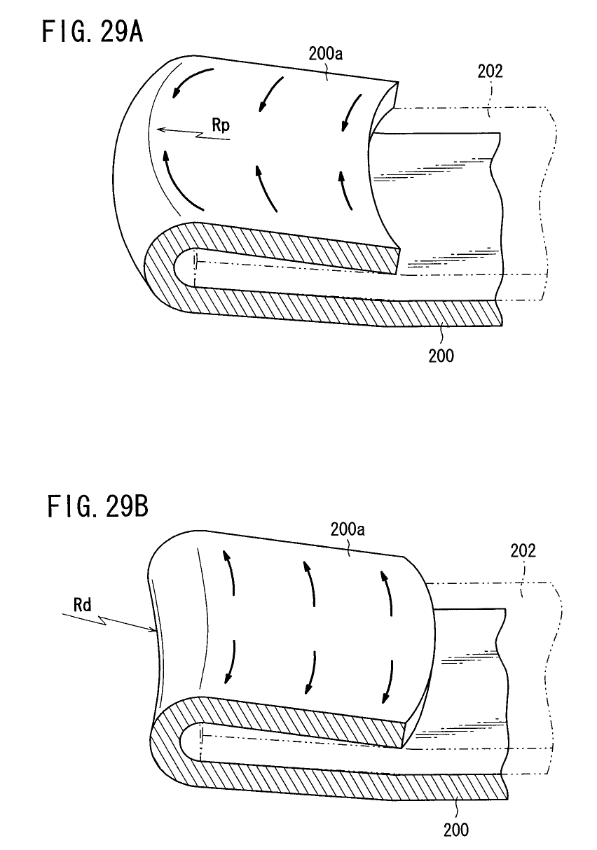

When the edge 118 of the panel member 100 is seamed, it undergoes forces in the directions indicated by the arrows in FIG. 15 even at the corner or the curvature portion shown in FIG. 14. Those forces are effective in preventing the distortions from occurring in the structure of the related art (see FIGS. 27 through 29B). Corners of smaller curvature can thus be processed into edges of good appearance without the need for reducing the length of the pre-curved flange.

With the panel member 100, the distal end of the second panel 122 to be included in the second edge 118b has the flange 122c (see FIG. 21B). When the flange 122c abuts against the inner surface of the outer panel 114, as shown in FIGS. 23B and 24B, the workpiece is prevented from buckling and developing an unduly round surface when the edge is curled and seamed, allowing the edge points O2 to be positionally aligned with the edge line O1 highly reliably.

The panel member 100 according to the present embodiment may selectively include an edge which is curled only and an edge which is curled and seamed depending on the location to which the panel member 100 is to be applied, e.g., depending on the fastening strength and the required appearance and shape appropriate for a door, a hood, or the like to which the panel member 100 is to be applied. For example, if the panel member 100 is to be applied to a location where the required fastening strength is relatively small, then the edge of the panel member 100 may be curled only. If the panel member 100 is to be applied to a location where the required fastening strength is higher, then the edge of the panel member 100 may be curled and seamed.

The panel member 100 according to the present embodiment is of increased appearance because it has a uniform flange even it is used as a three-dimensional edge including many curvatures, such as the rear automobile door 112.

The seamed edge 118 has an essentially constant height (thickness) to provide a seamed configuration of good appearance even in the vicinity of the boundary line W where the first and second panels 120, 122 of different thicknesses (shapes), i.e., different rigidities, are joined to each other, because the first and second panels 120, 122 have different lengths (the distances LA, LB) and the recess 124 is provided.

Specifically, the edge 118 of good appearance can be formed by setting the first panel 120 of lower rigidity to the distance LA, setting the second panel 122 of higher rigidity than the first panel 120 to the distance LB, and curling the edges of the first and second panels 120, 122. Since the recess 124 functioning as a clearance (escape) at the time the edge is seamed is provided in the ranges C, C (see FIG. 20) including the boundary line W, the inner panel 116 is prevented from being abruptly deformed in irregular directions, and from buckling for better appearance, when the edge is seamed even in the vicinity of the boundary line W where the two panels (the first panel 120 and the second panel 122) of different rigidities are joined to each other. The recess 124 should preferably be defined in a range which will not adversely affect the appearance after the edge is fastened, i.e., a range in which the distal end surfaces 120b, 122b are entrapped in the edge 118 and will not be exposed to the outside out after the panel member 100 is formed.

Furthermore, inasmuch as the distal end surface 114a of the outer panel 114 and the distal end surfaces 120a, 122a and 120b, 122b of the inner panel 116 are seamed without being exposed to the outside, those distal end surfaces do not need to be treated for rust prevention, and hence the cost of the panel member 100 and the number of manufacturing steps therefor are reduced.

In the edge 118, the panels are stacked and fastened in four or five layers as described above. Therefore, the panel member 100 is of greater fastening strength and hence is stronger than the hemming structure of the related art. The seamed edge 119 is thus of increased fastening strength.

The panel member 100 according to the present embodiment is also applicable to other automobile components other than the rear automobile door 112. For example, as shown in FIG. 16, as with the panel member 10 according to the preceding embodiment, the panel member 100 may be used as a front automobile door 50, a hood 52, a trunk lid 54, or the like. If the panel member 100 is used as the hood 52, then it may include a panel of higher rigidity in a portion thereof near its hinged end (hinged portion), such as a portion including an edge facing the front windshield of the automobile, and a panel of lower rigidity than the panel of higher rigidity in the remaining portion thereof. At the side edges of the hood 52 which extend forwardly from the respective opposite ends of the edge facing the front windshield, the panel may have different lengths near a boundary line extending substantially parallel to the edge facing the front windshield, and may have a recess defined therein, so that the edge facing the front windshield may be of good appearance.

In the illustrated embodiments, the panel member 10 (100) comprises two panels, i.e., the outer panel 14 (114) and the inner panel 16 (116). However, the panel member according to the present invention may comprise three or more panels.

The outer panel 14 and the inner panel 16 have different thicknesses to provide different rigidities in the illustrated embodiment. However, the outer panel 14 and the inner panel 16 may be of substantially the same thickness, but may have different material strengths. The inner panel 116 comprises the first panel 120 and the second panel 122 which have different thicknesses to provide different rigidities in the illustrated embodiment. However, the first panel 120 and the second panel 122 may be of substantially the same thickness, but may have different material strengths.

Although certain preferred embodiments of the present invention have been shown and described in detail, it should be understood that various changes and modifications may be made therein without departing from the scope of the appended claims.

What is claimed is:

1. A panel member comprising:
at least a first plate member and a second plate member which are superimposed one on the other and have a seamed edge;
said first plate member including an end enclosed by said first plate member and gripped between said first plate member and said second plate member in said seamed edge;
said second plate member including a curved portion in an edge thereof;
said first plate member and said second plate member being stacked in at least four layers.

2. A panel member comprising:
at least a first plate member and a second plate member which are superimposed one on the other and have a seamed edge;
said seamed edge including:
a seamed first shape in which said first plate member includes an end enclosed by said second plate member and said second plate member includes an end enclosed by said first plate member; and
a seamed second shape in which said end of said second plate member is enclosed by said first plate member and said end of said first plate member is not enclosed by said second plate member.

3. A panel member according to claim 2, wherein at least one of said first plate member and said second plate member includes regions of different rigidities.

4. A panel member according to claim 3, wherein said one of the first plate member and the second plate member includes a recess defined in a range extending from said seamed edge at a boundary in which said regions of different rigidities are joined to each other.

5. A panel member according to claim 3, wherein said regions of different rigidities include at least a first region having a first rigidity and a second region having a second rigidity higher than said first rigidity;
said first region being included in an edge of said first shape, and said second region being included in an edge of said second shape.

6. A panel member according to claim 5, wherein said first region and said second region include respective portions of different lengths which are included in said seamed edge.

7. A panel member according to claim 5, wherein said one of the first plate member and the second plate member includes a recess defined in a range extending from said seamed edge at a boundary in which said regions of different rigidities are joined to each other.
